(19) United States
(12) Patent Application Publication
(10) Pub. No.: US 2017/0188602 A1
(43) Pub. Date: Jul. 6, 2017

(54) GUMMY ANIMAL TREAT AND METHOD OF PREPARATION

(71) Applicant: Kansas State University Research Foundation, Manhttan, KS (US)

(72) Inventors: Sarah L. Mathe, Saint Marys, KS (US); Greg Aldrich, Topeka, KS (US)

(21) Appl. No.: 15/322,541

(22) PCT Filed: Jul. 2, 2015
(86) PCT No.: PCT/US15/39040

§ 371 Date: Dec. 28, 2016

Related U.S. Application Data
(60) Provisional application No. 62/020,224, filed on Jul. 2, 2014.

(51) Int. Cl. A23K 20/163; A23K 50/00; A23K 40/20

(52) U.S. Cl. CPC A23K 20/163; A23K 40/20; A23K 50/00

(57) ABSTRACT

A process of forming a gelatin-based animal treat is provided. The process comprises forming a composition comprising a gelatin component, a carbohydrate material, and an aqueous liquid. The compositions comprising the animal treat general have less than about 1% by weight of acidulants and a pH from about 5.5 to about 8.0. Once the composition is introduced into a product mold, it is allowed to cool and harden into the gelatin-based treat product. Thus, the animal treats are cold-setting and do not require additional heating, cooking, or baking to form the final product. Optionally, the animal treat can be used as a carrier to deliver a pharmaceutical or nutraceutical compound to the animal through ingestion.

### CROSS-REFERENCE TO RELATED APPLICATION

This application claims the benefit of U.S. Provisional Application No. 62/020,224, filed Jul. 2, 2014.

### BACKGROUND OF THE INVENTION

Field of the Invention

The invention generally relates to gummy animal treats having a texture and flavor desirable to household pets or other animals. The treats may also be formulated to have other desirable characteristics.

Description of the Prior Art

The Pet Food Industry is a $23 billion dollar enterprise in North America. Currently there are numerous baked, extruded, and injection molded treats, biscuits, cookies, and chews. Current dog treats on the market are primarily starch based baked biscuits. However, dogs and cats have an appetite for protein. Therefore a more appropriate application is one in which gelatin (hydrolyzed animal bones) is used as the base format for a treat. Currently, gelatin is not used much in the pet industry as a main ingredient in food, treats, or other products, and there are challenges with this functional food compound due to its softness at room temperature. Overcoming some of these challenges with a pet food treat application could create an entirely new product segment. U.S. Pat. Nos. 4,904,494, 4,904,495, 4,997,671 (all related) and U.S. Pat. No. 6,716,470 contain further relevant background information.

### SUMMARY OF THE INVENTION

In one embodiment of the present invention, there is provided a process of forming an animal treat. The process comprises forming a composition comprising a gelatin component, a carbohydrate material, and an aqueous liquid. The composition comprises less than about 1% by weight of acidulants. The composition is introduced into a product mold and caused to harden within the mold, thereby forming the animal treat product.

In another embodiment, there is provided a process of forming an animal treat. The process comprises forming a composition comprising a gelatin component, a carbohydrate material, and an aqueous liquid. The composition has a pH of from about 5.5 to about 8.0. The composition is introduced into a product mold and caused to harden within the mold, thereby forming the animal treat product.

In another embodiment, an animal treat composition is provided. The composition comprises an admixture of a gelatin component, a carbohydrate material, and an aqueous liquid. The composition comprises less than about 1% by weight of acidulants.

In another embodiment, a method of feeding an animal is provided. The method comprises feeding the animal a treat comprising a composition that comprises an admixture of a gelatin component, a carbohydrate material, and an aqueous liquid.

### BRIEF DESCRIPTION OF THE DRAWINGS

FIG. 1 is a photograph of certain gelatin-based products according to the present invention and the mold in which they were prepared; and

FIG. 2 is a flow diagram of the process of forming a gelatin-based gummy animal treat according to one embodiment of the present invention.

### DETAILED DESCRIPTION OF THE PREFERRED EMBODIMENT

Currently there are many pet treats that use extrusion, baking, or injection molding to shape and cook the treats. The gelatin-based treat according to embodiments of the present invention is a cold set product that does not require the high temperatures of these processing methods. Additionally, the gelatin-based treat remains stable for extended periods of time at room temperature without the use of acidulants commonly utilized in food processing. In certain embodiments, the product comprises, consists of, or consists essentially of gelatin, a carbohydrate material, an aqueous liquid, and optionally, one or more further ingredients described herein.

The gelatin-based treat according to embodiments of the present invention is prepared by forming a composition comprising an admixture of a gelatin component, a carbohydrate material, and an aqueous liquid. The composition is then introduced into a product mold and caused to harden within the mold to form the cold set product. The ingredients used in forming the inventive compositions and product, as well as the methods of forming the same, are described in more detail below.

The animal treats according to embodiments of the present invention are gelatin-based animal treats, and thus the animal treats comprise a gelatin component, which may include one or more gelatins. Gelatin is a mixture of peptides and proteins produced by partial hydrolysis of collagen extracted, for example, from the skin, bones, and connective tissues of animals such as domesticated cattle, chicken, pigs and fish. Gelatin is distinguished from other types of animal-derived protein sources, such as skeletal muscle, and offal or organ meats, which are relatively low in collagen. The approximate amino acid composition of gelatin is: glycine 21%, proline 12%, hydroxyproline 12%, glutamic acid 10%, alanine 9%, arginine 8%, aspartic acid 6%, lysine 4%, serine 4%, leucine 3%, valine 2%, phenylalanine 2%, threonine 2%, isoleucine 1%, hydroxylysine 1%, methionine and histidine <1% and tyrosine <0.5% In certain embodiments, gelatin contains no tryptophan and is deficient in isoleucine, threonine, and methionine. The precise values for the amino acid components of gelatin may differ depending on the source of the raw material and the processing technique.

Advantageously, bovine bone gelatin has little to no risk associated with bovine spongiform encephalopathy (BSE), commonly known as Mad Cow disease, compared to other types of animal-derived protein sources. Gelatin, when dissolved in hot water, may form a semi-solid gel upon cooling. Because of this, gelatin can be used as a stabilizer, thickener, or texturizer in food products. Suitable gelatins include, for example, Knox, Rousselot, or Sonac brand gelatins, although it should be understood that other brands of gelatin may also be used. In certain embodiments, the gelatin comprises the predominant protein source in the product, and the use of other animal-derived proteins is largely avoided, with the exception of their incorporation as flavoring agents. However, even when flavoring agents are used, at least 75%, at least 80%, at least 90%, at least 95%, or at least 97% by weight of the protein content of the product is attributable to gelatin. In certain embodiments, the gummy treat formulation comprises from about 15% to about 50% by weight of gelatin, more preferably from about 20% to about 45% by weight of gelatin, even more preferably from about 25% to about 40% by weight of gelatin. In certain embodiments, the product comprises greater than or equal to about 30% by weight of gelatin, more preferably greater than or equal to about 35% by weight of gelatin.

The strength of the gelatin has a significant impact on achieving the desired characteristics of the animal treat product. For example, the use of greater strength gelatin can increase the resilience of the gelatin-based product. The Bloom test is a test commonly used to measure the strength of a gel or gelatin. This test determines the weight (in grams) needed by a probe (normally with a diameter of 0.5 inch) to deflect the surface of the gel 4 mm without breaking it. The result is expressed in Bloom (grades) and is usually between 30 to 300 Bloom. To perform the Bloom test on gelatin, a 6.67% gelatin solution is kept for 17-18 hours at 10° C. prior to being tested. In certain embodiments of the present invention, the gelatin used in creating the formulations is between about 50 to about 275, about 75 to about 250, or about 100 to about 225 Bloom. In certain embodiments, the gelatin component comprises at least two gelatins having different Bloom values. In certain embodiments, at least one of the two or more gelatins has a high Bloom value. For example, in such embodiments, at least one of the two or more gelatins has a Bloom value of about 50 or greater, or about 100 or greater.

The carbohydrate material may comprise one or more members selected from the group consisting of mono-, oligo- and polysaccharides. In certain embodiments, the carbohydrate comprises a polysaccharide, such as starch. Starch generally comprises two types of molecules: the linear and helical amylose molecule, and the branched amylopectin molecule. In particular embodiments, the starch is not sourced from a cereal grain, such as rice, wheat, or corn, but rather from root vegetables such as potato, cassava (tapioca), and various legumes. Thus, in certain embodiments, the products are grain-free and/or gluten-free. Suitable starches include, for example, tapioca or unmodified potato starch, although other starches are also suitable. In certain embodiments, the starch may be native starch or a modified starch. It should be understood that other polysaccharides commonly used in food processing may also be used in accordance with the present invention. The polysaccharide is present in the composition in an amount of from about 5% to about 35%, from about 7.5% to about 30%, or from about 10% to about 20% by weight.

In certain embodiments, the product may comprise in place of or in addition to the starch, various mono- and oligosaccharides, such as found in dextrose, molasses, honey, or others. In certain embodiments, molasses may be used as a water binder, flavoring, and coloring agent. When used in addition to the starch or other polysaccharide, the mono- and oligosaccharides are present in the composition in an amount from about 0% to about 30%, about 5% to about 25%, or from about 10% to about 20% by weight. Therefore, the total amount of carbohydrate material (i.e., polysaccharides, monosaccharides, and oligosaccharides) present in the composition is generally from about 5% to about 60%, from about 15% to about 55%, or from about 20% to about 35% by weight.

The aqueous liquid generally comprises water as the predominant component. In certain embodiments, the aqueous liquid is water. However, flavorings may also be included in the aqueous liquid component in order to impart a desired flavor or taste to the product. In certain embodiments, various broths, such as beef or chicken broth, may be employed. Other natural and artificial flavorings may be included in order to produce a palatable treat for the animal. The aqueous liquid facilitates the dissolution and/or mixture of the dry ingredients. Thus, the aqueous liquid must be present in an amount great enough to dissolve the gelatin powder, starch, and other dry components that comprise the admixture. For example, the aqueous liquid should be present in the composition in an amount of about 7.5% to about 40%, from about 10% to about 35%, or from about 15% to about 25% by weight.

The gelatin-based treats may also comprise one or more polyols or polyhydric alcohols, such as glycerin, which function as a water binder and/or flavor enhancer. In particular embodiments, the glycerin is a vegetable-derived glycerin. Also, certain products made in accordance with the present invention may also exhibit relatively high water activities, which may translate into a relatively short product shelf life. Therefore, one or more food preservatives, such as potassium sorbate, may be incorporated into the products so as to inhibit mold or bacterial growth, thereby extending the product's shelf life. Other natural or artificial preservatives commonly used in the food processing and pet industry may also be used. Additional ingredients may also be used to aid in the mixing/preparation of the inventive compositions and products. For example, optional thickeners and anti-foaming agents may be added to the liquid mixtures to aid in the mixing and molding of the compositions.

To prepare the products according to certain embodiments of the present invention, the various ingredients are combined and mixed until a substantially homogeneous solution is obtained. Generally, the aqueous liquid will be at or near its boiling point when mixed with the gelatin and carbohydrate materials to facilitate solution formation. In certain embodiments, the aqueous liquid may be heated to a temperature of at least 175° F., at least 180° F., or at least 190° F. In other embodiments, the aqueous liquid is heated to a temperature of from about 175° F. to about 225° F., from about 185° F. to about 220° F., or from about 195° F. to about 215° F. The liquid solution may then be poured into molds and allowed to solidify at ambient temperature or below, if more rapid setting is desired. Thus, in certain embodiments, the products are not cooked, baked, or extruded (subjected to heat and pressure) after being poured into molds, but are cold setting. The resulting gel has a soft, gelatinous texture that is highly palatable for household pets, especially dogs and cats. Upon removal from its mold, the gel comprises a self-sustaining body, that is, a body that retains its as-molded shape without requiring external, or non-intrinsic support. The gel may also be quite elastic, returning to its original shape upon exposure to a deforming force.

In certain embodiments, the gelatin-based animal treats can be prepared by first mixing the gelatin component with a carbohydrate material such as starch, molasses, or combinations thereof. The use of other carbohydrate materials are also within the scope of the present invention. Boiling water or broth is then added to the gelatin/starch mixture to form a homogenous liquid mixture. The heated liquid mixture is then poured into a product mold and caused to cold-set (harden) at a temperature below about 80° F. (e.g., room temperature).

In other embodiments of the present invention, the carbohydrate material and gelatin component are each separately mixed with water or broth before being combined into a homogenous mixture. For example, warm or boiling water is added to a polysaccharide such as starch, and boiling water or broth is added to the gelatin component. The starch mixture is then added to the gelatin mixture and mixed thoroughly to produce a homogenous heated liquid mixture. The liquid mixture is then poured into a product mold and allowed to set under conditions such as those described above.

In other embodiments, all of the dry ingredients may be mixed prior to being mixed with the aqueous liquid. For example, the gelatin component and a dry carbohydrate material are combined and mixed to form a homogenous powdered mixture. Warm or boiling water or broth is then added to the powdered mixture and mixed thoroughly to produce a heated liquid mixture. The heated liquid mixture is then poured into a product mold and allowed to set.

In still other embodiments, additional ingredients may be added at various stages in the preparation of the products. In such embodiments, for example, warm or boiling water or broth is first added to a mixture of glycerin and starch. Separately, warm or boiling water or broth is added to the gelatin component and mixed thoroughly. Molasses is then added to the gelatin mixture and mixed thoroughly. The glycerin/starch mixture is then introduced into the gelatin/molasses mixture and mixed into a homogenous liquid mixture. The homogenous liquid mixture is then poured into a product mold and allowed to set.

In yet another embodiment, powdered preservatives may be mixed with the gelatin component early in the production. In such embodiments, for example, potassium sorbate is added to the gelatin component. Separately, warmed molasses is added to a mixture of glycerin and starch. Warm or boiling water or broth is then added to the molasses/glycerin/starch mixture. This liquid molasses/glycerin/starch mixture is then added to the gelatin/potassium sorbate mixture and mixed thorough to form a homogenous liquid mixture. The liquid mixture is then poured into a product mold and allowed to set.

In the above embodiments, the liquid mixtures comprising gelatin should be kept at a temperature above about 80° F., above about 90° F., or above about 100° F. prior to being molded and caused to cold-set. The gelatin-based liquid compositions may begin to irreversibly harden if allowed to cool below such temperatures. Thus, additional heating steps may be required at various stages throughout the above methods in order to keep the liquid compositions from cooling. For example, the combined homogenous liquid mixtures may be heated prior to being molded (e.g., poured into molds) in order to maintain a liquid state. However, once the gelatin-based compositions have been molded, no other heating steps (i.e., cooking, conditioning, etc.) are necessary to form the final animal treat product. That is, once the gelatin-based liquid compositions are molded, they are caused to cool and harden without exposing the molded compositions to any additional heat source. It should be understood that the above-described methods provide a non-exhaustive list of examples of methods utilized in accordance with the present invention, but combinations of the above methods and other methods may also be used within the scope of the present invention.

In certain embodiments of the invention, the products contain relatively low quantities of an acidulant or are acidulant-free. As used herein, “acidulant” refers to an edible organic acid, an edible inorganic acid, an edible acid salt, or combinations thereof. Such acidulants are sometimes used in the food industry to lower pH or to impart a particular flavor onto a food product. In particular embodiments, the products comprise less than 1%, less than 0.5%, less than 0.1%, or less than 0.01% by weight of acidulants. In certain embodiments, the products do not contain any functionally significant quantities of acetic acid, citric acid, fumaric acid, lactic acid, malic acid, succinic acid, adipic acid, propionic acid, sorbic acid, phosphoric acid, tartaric acid, hydrochloric acid, or sulfuric acid, or the salts thereof. Moreover, in certain embodiments, the products do not contain any functionally significant quantities of monobasic sodium phosphate, monocalcium phosphate, aluminum sulfate, aluminum calcium sulfate and aluminum sodium sulfate. In certain embodiments, the product, as measured before setting, may have a pH of between about 5.0 to about 8.0, between about 5.5 to about 7.5, or between about 6.0 to about 6.5. In certain embodiments, the products are relatively low in fat, comprising less than about 5%, 2%, 1%, or 0.5% by weight fat. In other embodiments, the products are substantially fat-free.

The following Table summarizes various product formulations that may be produced in accordance with the present invention.

| | Broad | | Narrow |
|---|---|---|---|
| | range | Intermediate | range (wt. |
| Ingredient | (wt. %) | range (wt. %) | %) |
| Gelatin | 15-50% | 20-45% | 25-40% |
| Carbohydrate material | 5-60% | 15-55% | 20-35% |
| Polysaccharide (e.g., starch) | 5-35% | 7.5-30% | 10-20% |
| Mono-/Oligosaccharide (e.g., | 0-30% | 5-25% | 10-20% |
| molasses) | | | |
| Aqueous liquid | 7.5-40% | 10-35% | 15-25% |
| (e.g., water/broth) | | | |
| Polyhydric alcohol | 0-25% | 5-20% | 7.5-17.5% |
| (e.g., glycerin) | | | |
| Preservative | 0-10% | 0.01-5% | 0.1-2.5% |

As described above, the animal treat products made in accordance with the methods of the present invention are gelatin-based animal treat products. Accordingly, the animal treats comprise a gelatin component comprising one or more gelatins. The one or more gelatins may have the same or different strengths (Bloom values) and are selected in order to impart the desired textural characteristics on the animal treat. The amount of gelatin component within the composition will also have an impact on the texture of the product. Carbohydrate materials, such as starch and molasses, are added in amounts that impart desirable stability and texture to the products. Aqueous liquid is added in amounts sufficient to cause the solid ingredients to dissolve but little enough to still allow the composition to cold-set upon cooling. Polyhydric alcohol and optional preservatives may also be added to improve stability and shelf-life of the products.

In certain embodiments, products produced according to the present invention remain shelf stable for a period of at least 30 days, at least 60 days, or at least 120 days when stored at room temperature (about 75° F.) in a reclosable container. In certain embodiments, the products produced according to the present invention remain shelf stable for at least four months, or more preferably for at least 1 year when stored at room temperature. The products remain shelf stable for these durations even when exposed to various amounts of sunlight. As used herein, “shelf stable” means that the product has no apparent mold growth, has not melted or become liquid, and has retained its shape and solid state characteristics. As used herein, “shelf life” refers to the minimum duration of time that the product remains shelf stable when stored at room temperature.

The shelf stability of the animal treats will be at least partially dependent upon their water activity. Water activity is the partial vapor pressure of water in a substance divided by the standard state partial vapor pressure of water. In the field of food science, for example, the standard state is most often defined as the partial vapor pressure of pure water at the same temperature. Thus, the water activity of the products is dependent upon water vapor pressure and temperature. Water activity is related to shelf stability in that keeping a product below a certain water activity generally inhibits mold growth and results in a longer shelf life. Accordingly, the animal treats made in accordance with the present invention have a water activity less than about 0.80, preferably less than about 0.75, even more preferably less than about 0.70, and most preferably less than about 0.65, when tested at about room temperature (about 24° C. or about 75° F.). In certain embodiments, the animal treats have a water activity of from about 0.50 to about 0.80, from about 0.55 to about 0.75, or from about 0.60 to about 0.70, when tested at about room temperature (about 24° C. or about 75° F.).

The animal treats produced in accordance with the present invention are formed having textures that are desirable to animals, such as cats and dogs. The treats will have desirable springiness, gumminess, chewiness, and resilience. For example, the products will have a peak force of deformation of about 0.3 kg to about 4.0 kg, about 0.5 kg to about 3.0 kg, or about 0.75 kg to about 2.75 kg, when tested using TA.XT2i Texture Analyzer, equipped with 50-kg load cells and a 25 mm cylindrical probe with a pretest speed of 1 mm/sec, a test speed of 0.5 mm/sec, a post test speed of 10 mm/sec, and a strain load set at 50%.

The animal treats prepared in accordance with the present invention have extended stability and shelf-life due, in part, to their ability to retain moisture. For example, animal treat products of the present invention exhibit a moisture loss of less than about 20% when placed in a drying oven set at 70° C. (158.0° F.) for a time period of 15 days. In certain embodiments, the animal treat products exhibit a moisture loss of less than about 30%, less than about 25%, less than about 15%, or less than about 10% moisture loss when stored in ambient conditions (room temperature and pressure) for 30 days.

In certain embodiments, the final product may become malleable at about 80-90° F., and may melt at temperatures exceeding about 90° F. However, if the product is allowed to cool to temperatures below about 80° F. following exposure to a temperature above about 80° F., the product will become solid and retain that shape without detrimental effects to the product. In general, products according to the present invention are thermally stable in that they remain a solid at or about room temperature.

The gelatin-based product of the present invention may be used as an animal treat, such as snack for a dog or cat. The animal treat may be used in the training of an animal, for example, as a positive reinforcement reward. The product may also be used as a general food source for an animal, as the gelatin component provides a greater amount of dietary protein than other carbohydrate-based foods. When used in accordance with one of the above methods, the product is fed to the animal by oral ingestion.

The gelatin-based treat may also be used as a carrier for various supplements (vitamins, minerals) and/or pharmaceuticals to be administered to an animal. For example, the treat may be used as a carrier for additives such as paraciticides (e.g., wormers, flea medications), nutraceuticals (e.g., chondroitin sulfate, glucosamine, MSM, egg shell membrane), nutrients (e.g., beta-carotene, lutein, zeaxanthin), or other compounds subject to losses by high temperature food preparation. The additives may be infused or dispersed in the gelatin-based treat by methods well known in the art.

### EXAMPLES

The following examples set forth methods of preparing the gelatin based animal treats of the various embodiments of the present invention. It is to be understood, however, that these examples are provided by way of illustration and nothing therein should be taken as a limitation upon the overall scope of the invention.

### Example I

Background.

Formulas for human gummy bears were found on multiple sites online. Through producing these products, a stiff gelatin based gummy bear was achieved. Modeling after these products, a formula was created containing: 3.25 oz gelatin, 1-2 oz starch, and 0.33-0.5 cups of water. This works out to 47% gelatin, 14.5% starch, and 38.3% water by weight. This became the base recipe for the initial experiment.

Testing.

The gelatin was evaluated at three inclusion levels: low(L), medium(M), and high(H). The starch was evaluated at three inclusion levels: low(A), medium(B), and high(C). The water was evaluated at three inclusion levels: low(1), medium(2), and high(3). Treatment LxAx3 will serve as the control.

Ingredients and Equipment.

The ingredients used were: Kroger brand gelatin; Bob's Red Mill tapioca starch; and tap water (boiling). The equipment needed was: beakers; stir rods; hot plate; weigh boats; tin foil; scale; refrigerator; product mold; and graduated cylinders.

Procedure.

All dry ingredients were placed into weigh boats. The gelatin and tapioca starch were mixed together in a beaker until the mixture was thoroughly combined. Boiling tap water was added to the mixture and mixed with the gelatin and tapioca starch until thoroughly blended. The mixture was then poured into a mold, covered with tin foil, and placed in the refrigerator. This procedure was repeated using the proportions of gelatin, starch, and water shown in Table 1.

TABLE 1
Treatments and proportions of gelatin, starch and water.

| | Gelatin | | Starch | | Water | | Total | |
|---|---|---|---|---|---|---|---|---|
| | % | Grams | % | Grams | % | Grams | % | Grams |
| L × A × 3 | 47 | 141 | 15 | 45 | 38 | 114 | 100 | 300 |
| L × B × 2 | 47 | 141 | 20 | 60 | 33 | 99 | 100 | 300 |
| L × C × 1 | 47 | 141 | 25 | 75 | 28 | 84 | 100 | 300 |
| M × A × 3 | 52 | 156 | 15 | 45 | 38 | 114 | 100 | 300 |
| M × B × 2 | 52 | 156 | 20 | 60 | 33 | 99 | 100 | 300 |
| M × C × 1 | 52 | 156 | 25 | 75 | 28 | 84 | 100 | 300 |
| H × A × 3 | 57 | 171 | 15 | 45 | 38 | 114 | 100 | 300 |
| H × B × 2 | 57 | 171 | 20 | 60 | 33 | 99 | 100 | 300 |
| H × C × 1 | 57 | 171 | 25 | 75 | 28 | 84 | 100 | 300 |

Results.

It was decided to produce treatment LxAx3 before moving onto the other treatments. When boiling tap water was added to the dry powders, the resulting product was very thick and would not fully mix. To achieve a fully mixed product, 20 g of additional boiling tap water was required. This created a very thick mixture similar to “wallpaper paste” that set-up within an hour of being formed. This product had to be peeled out of the beaker and was retained in one solid piece. This product sat on the counter at room temperature throughout the day. The thinner gelatin mixture at the top of the product began to dry out and crack when bent unlike the thicker bottom portion of the product.

### Example II

Background.

Building on Example I, it was found that gelatin-based substances can be temperature stable at 75° F. and do not show gelatin's thermoplastically reversible characteristics. From this work, it was determined that a range of inclusion rates falling somewhere between treatment LxAx3 and 50% of the gelatin and starch content of trial LxAx3 was needed to produce a stable treat with stable thermoplastic properties when held at room temperature.

Ingredients and Equipment.

The ingredients for this experiment were the same as Example I. The equipment needed was: beakers; stir rods; hot plate; weigh boats; tin foil, scale; product mold; and graduated cylinders.

Procedure.

First, all dry ingredients were weighed out into weigh boats. Then, lukewarm tap water was added in an amount equal to the tapioca starch content required for each treatment. Once all lukewarm water was added, tapioca starch and water was mixed in a beaker until fully dissolved and set aside. The Kroger gelatin was then poured into an empty beaker. Boiling tap water was weighed and poured onto the gelatin, without stirring. The cool tap water/tapioca starch mixture was stirred into homogenous solution and poured over the boiling tap water/gelatin mixture. The combined mixture was mixed until all ingredients were well blended and poured into molds. The molds were covered and refrigerated until the product was set. This procedure was repeated using each of the gelatin, starch, and water proportions shown in Table 2.

TABLE 2
Treatments and respective gelatin, starch and water concentrations.

| Gelatin | | Starch | | Water | | | | Total |
|---|---|---|---|---|---|---|---|---|
| TRT | g | TRT | g | TRT | Cold (g) | Boiling (g) | Total | g |
| H | 141 | A | 45 | 5 | 45 | 69 | 114 | 300 |
| MH | 123 | B | 40 | 4 | 40 | 97 | 137 | 300 |
| M | 105.5 | C | 33.5 | 3 | 34 | 127 | 161 | 300 |
| ML | 87.5 | D | 27.5 | 2 | 28 | 128 | 156 | 270 |
| L | 70 | E | 22 | 1 | 22 | 186 | 208 | 300 |

Results.

The treatment combination MxCx3 had the least clumps of gelatin. Treatment MLxDx2 was mistakenly mixed with only 128 g of boiling tap water instead of the specified 158 g, which resulted in a mixture which was too thick for the mold. However, it produced a very rigid product. Treatment HxAx5 required an additional 40 g of boiling tap water. It produced the largest gelatin clumps and the most numerous clumps of undissolved Kroger gelatin, and it set-up in the beaker shortly after mixing. In the lab setting, the clumps seemed to reduce in size if water was added to gelatin instead of gelatin added to water. The small “bean” size clumps started to firm before placement into the refrigerator. Further, larger cups were kept at room temperature (75° F.) and were still able to “set.” All samples were placed in direct sunlight at 78° F. during the trial period. The ML and L gelatin treatments became soft and melted to liquid in the cup, and the M gelatin (MxCx3) treatment held its shape until touched and then melted into liquid. The MHxBx4 treatment became soft but held its shape, while the highest trial gelatin level (HxAx5) weeped slightly but was not otherwise affected after the initial set. It was noted that in direct sunlight the shape was not affected, and the piece did not melt and soften to touch.

Conclusions.

The higher gelatin trials were more resilient at handling temperatures above 75° F. The lower gelatin concentrations, while easier to mix and pour, did not hold up as well.

### Example III

Background.

Using the information learned from Examples I and II, it was decided to test gelatin of different Bloom strengths for the use in the base formula. The gelatins used were a range of different Rousselot gelatins and Sonac's Pro Bind Plus gelatin. It was believed that some Bloom strength of gelatin and starch would yield a product similar to HxAx5 from Example II.

Ingredients and Equipment.

The ingredients used were: Rousselot 100 H Bloom strength; Rousselot 100 PS Bloom strength; Rousselot 175 PS Bloom strength; Rousselot 225 H Bloom strength; Rousselot 250 PS Bloom strength; Sonac Pro Bind Plus; Bob's Red Mill tapioca starch; and tap water. The equipment used was the same as the previous experiment, except no refrigerator was used.

Procedure.

First, all dry ingredients were weighed out into weigh boats. Second, the tapioca starch and gelatin were mixed in a beaker until fully combined. Boiling tap water was weighed out and poured into the gelatin/starch mixture. The combined mixture was mixed until all ingredients were well combined, poured into molds, and covered with tin foil. This procedure was repeated using the gelatin, starch, and water proportions shown in Table 3.

TABLE 3
Treatments and respective gelatin, starch and water concentrations.

| | Gelatin | | Starch | | Water | | Total | |
|---|---|---|---|---|---|---|---|---|
| | % | g | % | g | % | g | % | g |
| R 100 H | 47 | 47 | 45 | 45 | 38 | 38 | 100 | 100 |
| R 100 PS | 47 | 47 | 45 | 45 | 38 | 38 | 100 | 100 |
| R 175 PS | 47 | 47 | 45 | 45 | 38 | 38 | 100 | 100 |
| R 225 H | 47 | 47 | 45 | 45 | 38 | 38 | 100 | 100 |
| R 250 PS | 47 | 47 | 45 | 45 | 38 | 38 | 100 | 100 |
| S Pro | 47 | 47 | 45 | 45 | 38 | 38 | 100 | 100 |
| Bind | | | | | | | | |

Results.

S Pro Bind: Thick, semi-pourable liquid that started to set-up almost immediately in beaker. Other observations and characteristics:
completely dissolved in boiling tap water
crumbled coming out of mold
product set up after 30 minutes

R 100 H: Very gritty mixture, and gelatin did not dissolve completely in boiling tap water. Other observations and characteristics:
additional 10 g of boiling tap water did not help with clumping or gritty texture
product was not moldable

R 100 PS: Very gritty mixture, and gelatin did not dissolve completely in boiling tap water. Other observations and characteristics:
additional 10 g of boiling tap water did not help with clumping or gritty texture
product was not pourable
product set-up in mold within 5 minutes
bread-like appearance (many small air bubbles) when pulled from mold

R 175 PS: Very gritty mixture, and gelatin did not dissolve completely in boiling tap water. Other observations and characteristics:
additional 10 g of boiling tap water did not help with clumping or gritty texture
product was not mold-able

R 225 H: Very gritty mixture, and gelatin did not dissolve completely in boiling tap water. Other observations and characteristics:
additional 10 g of boiling tap water did not help with clumping or gritty texture
product was not moldable

R 250 PS: Very slimy mixture, and gelatin almost completely dissolved in boiling tap water. Other observations and characteristics:
product was not pourable
product set-up in mold within 10 minutes
bread like appearance (many small air bubbles) when pulled from mold

Conclusions.

Higher concentrations of water were needed with all gelatin bloom strengths used in the above trials to produce measurable results. The gelatin bloom strengths that were able to be molded were all stable at room temperature (70° F.).

### Example IV

Background.

It was believed that some combination of different gelatin Bloom strengths together with starch would yield a treat that does not show thermoplastic properties at room temperature (72° F.). Trials were conducted with 50% Pro Bind Plus and 50% of a Rousselot gelatin mixed before the addition of boiling tap water.

Ingredients and Equipment.

The ingredients were the same as Example III. The equipment was the same as Example III, except for the addition of metal bowls.

Procedure.

First, all dry ingredients were weighed out into weigh boats. Next, Pro Bind gelatin and Rousselot gelatin were mixed together in a beaker. Tapioca starch was added into the dry gelatin mixture and stirred. Then, boiling tap water was weighed out and poured boiling into the dry ingredients. The combination was mixed until all ingredients were well combined, poured into molds, and covered with tin foil. This procedure was repeated using the gelatin, starch, and water proportions shown in Table 4.

TABLE 4
Treatments and respective gelatin, starch and water concentrations.

| | Gelatin | | | | | | | | | |
|---|---|---|---|---|---|---|---|---|---|---|
| | | g Pro | Total | | Starch | | Water | | Total | |
| | g | Bind | g | % | g | % | g | % | g | % |
| R 100 H | 70.5 | 70.5 | 141 | 47 | 45 | 15 | 114 | 38 | 300 | 100 |
| R 100 PS | 70.5 | 70.5 | 141 | 47 | 45 | 15 | 114 | 38 | 300 | 100 |
| R 175 PS | 70.5 | 70.5 | 141 | 47 | 45 | 15 | 114 | 38 | 300 | 100 |
| R 225 H | 70.5 | 70.5 | 141 | 47 | 45 | 15 | 114 | 38 | 300 | 100 |
| R 250 PS | 70.5 | 70.5 | 141 | 47 | 45 | 15 | 114 | 38 | 300 | 100 |

Results.

R 100 H/Pro Bind/Starch: Very thick, semi-pourable liquid that contained small clumps of undissolved gelatin. Other observations and characteristics:
product set-up at 30 minutes
product stuck to mold and did not release easily

R 100 PS/Pro Bind/Starch: Very thick, semi-pourable liquid that contained small clumps of undissolved gelatin. Other observations and characteristics:
took the longest amount of time to set up (3 hours)
product stuck to mold and did not release easily
small clumps of gelatin stuck to mold
product ripped apart easily

R 175 PS/Pro Bind/Starch: Very thick, spreadable liquid that contained small clumps of undissolved gelatin. Other observations and characteristics:
longer mixing times helped with gelatin clumping
product released from mold the cleanest out of the trials

R 225 H/Pro Bind/Starch: Gelatin was poured into water and small clumps of gelatin formed in the mixture. Other observations and characteristics:
product was not pourable
product was somewhat spreadable
product did not go into mold wells easily
product was very sticky before setting-up
setting product over boiling water for 30 seconds did not help

R 250 PS/Pro Bind/Starch: Very thick, semi-pourable liquid that contained small clumps of undissolved gelatin. Other observations and characteristics:
mixture cooled off the fastest and did not mix completely
placed mixture over boiling water for 20 seconds and continued mixing (×3) (total 4)
placing mixture over boiling water tap water helped to melt the mixture and dissolve more of the gelatin

All of the trials had many small air bubbles trapped within the product giving them a gritty, spotted appearance. All samples began molding within 3 days.

Conclusion.

Heating the liquid mixture before it sets helps dissolve the gelatin, but burning was a valid concern. Sonac Pro Bind gelatin required the least amount of water to completely dissolve in the available tap water.

### Example V

Background.

In Example IV, it was found that mixing the different gelatin Bloom strengths will create a room temperature stable product when mixed with starch and tap water. It was believed that some mixture of Sonac Pro Bind gelatin and starch would yield a gelatinous treat.

Ingredients and Equipment.

The ingredients used were: Sonac Pro Bind Plus;

Bob's Red Mill tapioca starch; and tap water. The same pieces of equipment were used in this experiment with the addition of an immersion blender.

Procedure.

First, all the dry ingredients were weighed out. Then, boiling tap water was weighed out equal to the amount of tapioca starch in every trial, and the boiling water was poured into the starch and mixed until combined. The remaining boiling water was weighed out for every trial and poured into gelatin. The gelatin and starch mixtures were combined with the blender until well combined. The product was poured into molds and covered with tin foil.

Test Regime.

Pro Bind Inclusion Levels: Low (1)—12%; Medium (2)—23%; High (3)—35%. Tapioca Starch Inclusion Levels: Low (1)—3%; Medium (2)—6%; High (3)—15%. Tap Water Inclusion Levels: varied with trials:
Low treatments: 73% (1,1) 59% (2,3) 50% (3,3)
Medium treatments: 74% (1,2) 70% (2,2) 62% (3,2)
High treatments: 85% (1,1) 82% (2,1) 73% (3,1)

TABLE 5
Treatments and respective gelatin, starch and water concentrations.

| | | | | | Tap Water | | | | | |
|---|---|---|---|---|---|---|---|---|---|---|
| | | | Tapioca | | Mixed | Mixed | | | | |
| Trial | Gelatin | | Starch | | with | with | Total | | | |
| (S, | (G) | | (S) | | starch | gelatin | Water | | Total | |
| G) | g | % | g | % | g | g | g | % | g | % |
| 1, 1 | 12 | 12 | 3 | 3 | 3 | 82 | 85 | 85 | 100 | 100 |
| 1, 2 | 23 | 23 | 3 | 3 | 3 | 71 | 74 | 74 | 100 | 100 |
| 1, 3 | 35 | 35 | 3 | 3 | 3 | 70 | 73 | 73 | 100 | 100 |
| 2, 1 | 12 | 12 | 6 | 6 | 6 | 76 | 82 | 82 | 100 | 100 |
| 2, 2 | 23 | 23 | 6 | 6 | 6 | 65 | 71 | 71 | 100 | 100 |
| 2, 3 | 35 | 35 | 6 | 6 | 6 | 53 | 59 | 59 | 100 | 100 |
| 3, 1 | 12 | 12 | 15 | 15 | 15 | 58 | 73 | 73 | 100 | 100 |
| 3, 2 | 23 | 23 | 15 | 15 | 15 | 44 | 59 | 59 | 100 | 100 |
| 3, 3 | 35 | 35 | 15 | 15 | 15 | 35 | 50 | 50 | 100 | 100 |

Results.

1,1: Very thin liquid, foamy, mixed well. Other observations and characteristics:
no clumps
did not set-up

1,2: Thin liquid, little to no clumps. Other observations and characteristics:
very tacky when set-up, “mashed potato” like appearance
did not release from mold in well

1,3: Extremely foamy, mixed well. Other observations and characteristics:
less tacky than (1,2), large air bubbles present
released from mold fairly cleanly

2,1: Very thin liquid, foam on top of mixture in mold. Other observations and characteristics:
did not set-up well
did not release from mold

2,2: JELL-O-like appearance once set up in mold, very fine air bubbles present in product. Other observations and characteristics:
very soft “mashed potato” like appearance when released from mold
did not release from mold cleanly

2,3: Large foam bubbles on top of liquid mixture when poured into mold. Other observations and characteristics:
released from mold cleanly, foam on top of product stuck to mold
play-dough like consistency and appearance

3,1: Very thin liquid, small fine air bubbles present within product. Other observations and characteristics:
some separation of starch/gelatin from water present in product
product did not release from mold cleanly

3,2: Mixture of large and fine bubbles within liquid, very tacky product. Other observations and characteristics:
“mashed potato” like consistency
did not release from mold cleanly

3,3: Took the least amount of time to set-up, very soft play-dough like consistency. Other observations and characteristics:
very fine air bubbles within product, product can be deformed easily with pressure
product released cleanly from mold

Conclusions.

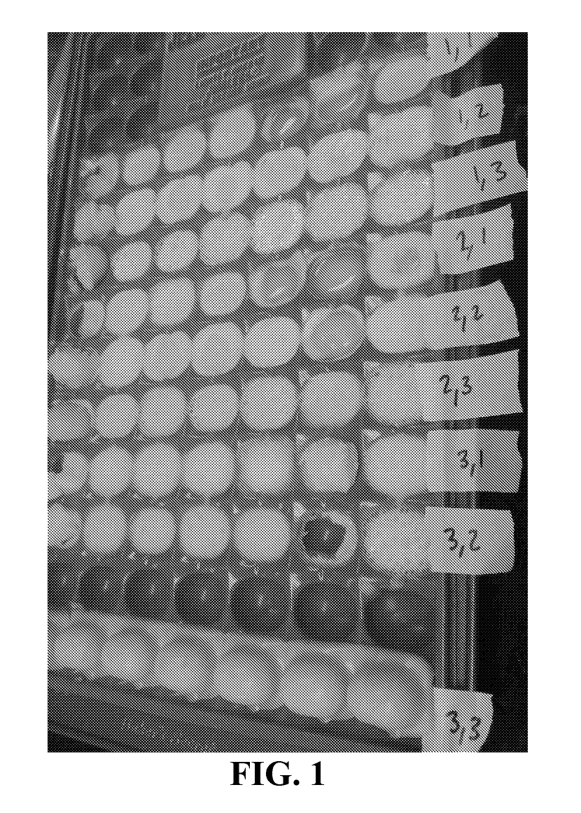

The treatments having lower concentrations of gelatin and starch did not produce desirable products. The levels of gelatin and starch should likely be somewhere between the 3,3 level and the inclusion level of LxAx3 from Example I in order to produce a desirable gelatinous treat. The product molds resulting from the above treatments are shown in the photograph of FIG. 1.

### Example VI

Background.

The lower concentrations of gelatin and tapioca starch did not result in desirable products. The effectiveness of tapioca starch to control the water activity was also questioned. It was therefore decided to recreate Example V using molasses instead of tapioca starch. It was believed that some combination of gelatin and molasses would yield a gelatinous treat.

Ingredients and Equipment.

The ingredients used were: Sonac Pro Bind Plus gelatin; Rousselot gelatin; Grandma's brand molasses; and tap water. The equipment used was the same as in Example V.

Procedure.

First, all of the dry ingredients were weighed out. Next, molasses was weighed out and poured on top of the gelatin. Then, the boiling water was weighed out and poured onto the gelatin and molasses. The gelatin, molasses, and tap water were mixed until combined, poured into molds, and covered with tin foil.

Test Regime.

Gelatin Inclusion Levels: Low (1)—12%; Medium (2)—23%; High (3)—35%.

Molasses Inclusion Levels: Low (1)—3%; Medium (2)—6%; High (3)—15%

Tap Water Inclusion Levels: Low—50%; Medium—71%; High—85%

TABLE 6
Treatments and respective gelatin, starch and water concentrations.

| | Gelatin | | Molasses | | Tap | | | |
|---|---|---|---|---|---|---|---|---|
| | (G) | | (M) | | Water | | Total | |
| (M, G) | g | % | g | % | g | % | g | % |
| Pro Bind (1, 1) | 12 | 12 | 3 | 3 | 85 | 85 | 100 | 100 |
| Pro bind (2, 2) | 23 | 23 | 6 | 6 | 71 | 71 | 100 | 100 |
| Pro Bind (3, 3) | 35 | 35 | 15 | 15 | 50 | 50 | 100 | 100 |
| R 175 (1, 1) | 12 | 12 | 3 | 3 | 85 | 85 | 100 | 100 |
| R 175 (2, 2) | 23 | 23 | 6 | 6 | 71 | 71 | 100 | 100 |
| R 175 (3, 3) | 35 | 35 | 15 | 15 | 50 | 50 | 100 | 100 |
| R 250 (1, 1) | 12 | 12 | 3 | 3 | 85 | 85 | 100 | 100 |
| R 250 (2, 2) | 23 | 23 | 6 | 6 | 71 | 71 | 100 | 100 |
| R 250 (3, 3) | 35 | 35 | 15 | 15 | 50 | 50 | 100 | 100 |

Results.

Pro Bind (1,1): Very thin liquid, did not come cleanly out of mold, not a desirable product, large air bubbles around edges of mold.

Pro Bind (2,2): Very thin liquid, did not come cleanly out of mold, not a desirable product, thick layer of fine air bubbles covering product in mold.

Pro Bind (3,3): Thick liquid, set-up in 1.5 hours, released from mold cleanly.

R 175 (1,1): Thinner liquid, thin layer of fine air bubbles on top of product in mold, released from mold easily but not without product damage.

R 175 (2,2): Semi-thick liquid, thin layer of fine air bubbles on top of product in mold, released from mold easily but not without product damage.

R 175 (3,3): Thick liquid, set-up in 1 hour, little to no air bubbles on top of product in mold, product released from mold cleanly.

R 250 (1,1): Thinner liquid, thin layer of fine air bubbles on top of product in mold, released from mold easily but not without product damage.

R 250 (2,2): Semi-thick liquid, thicker layer of fine air bubbles on top of product in mold, released from mold easily with little to no product damage.

R 250 (3,3): Thick liquid, set-up in 1 hour, little to no air bubbles on top of product in mold, product released from mold cleanly with minimal to no product damage.

Conclusions.

The immersion blender, while great at defeating gelatin clumps, imparts a large amount of air into the mixture and reduces the amount of usable mixture with the amount of foam created. An anti-foaming agent may be useful to address the foaming issue. The lower concentrations of gelatin and molasses created softer products that released from the mold cleanly but with some damage to the product occurring.

### Example VII

Background.

The gelatin and molasses combination was successful at dissolving all of the gelatin in the previous trials and producing a product that was stable at room temperature (75° F.). Therefore, in the following example, chicken broth replaced the tap water to impart flavor to the treats. The molasses was used as a water binder, flavoring, and coloring agent. The vegetable glycerin was used as a water binder and flavor enhancer. The native potato starch was used as a water binder and to provide structural support to the gelatin. It was believed that some amount of gelatin, starch, tap water, molasses, and vegetable glycerin would yield a gelatinous product.

Ingredients and Equipment.

The ingredients used were: Sonac Pro Bind Plus gelatin; Rousselot gelatin; Frontier brand vegetable glycerin; Grandma's brand molasses; Bob's Red Mill unmodified potato starch; and Kroger brand chicken broth. The equipment used was: beakers; stir rods; hot plate; weigh boats; tin foil; scale; product mold; immersion blender; graduated cylinders; and boiling tap water.

Procedure.

First, boiling water was poured into two beakers. A jar of molasses and empty graduated cylinder was placed in the beakers. Next, the starch was weighed out for all treatments. Then, vegetable glycerin was weighed out and poured into starch for all trials, mixed until combined, and set aside. Gelatin was weighed out for all treatments and the amount of gelatin needed for each trial was poured into separate dry beakers. The dry gelatin was mixed until combined. Boiling chicken broth was weighed out in an amount equal to the starch amount for each trial and mixed with starch and glycerin until combined. The remaining boiling chicken broth was weighed out for each trial, poured into dry gelatin mixture, and mixed until combined. Warmed molasses was weighed out into a warmed graduated cylinder, poured into chicken broth/gelatin mixture, and mixed until combined. The starch/glycerin/broth mixture was stirred to bring it back in solution and poured into gelatin/broth/molasses mixture. This combined mixture was mixed until well combined, poured into molds, and covered with tin foil

Test Regime.

Three levels of gelatin, starch, vegetable glycerin, molasses, and water were tested and three combinations of gelatin were tested, as shown in Tables 7 and 8.
Gelatin A=50% Pro Bind; 50% R 250
Gelatin B=50% Pro Bind; 50% R 175
Gelatin C=100% Pro Bind

TABLE 7

| | Pro Bind (g) | R 175 (g) | R 250 (g) | Total (g) |
|---|---|---|---|---|
| Gelatin A | 7.5 | 0 | 7.5 | 15 |
| Gelatin B | 10 | 10 | 0 | 20 |
| Gelatin C | 35 | 0 | 0 | 35 |

TABLE 8

| | Low (L) | | Medium (M) | | High (H) | |
|---|---|---|---|---|---|---|
| | g | % | g | % | g | % |
| Gelatin Mix | 15 | 15 | 20 | 20 | 35 | 35 |
| (A, B, C) | | | | | | |
| Molasses | 5 | 5 | 10 | 10 | 15 | 15 |
| Glycerin | 5 | 5 | 10 | 10 | 15 | 15 |
| Starch | 5 | 5 | 10 | 10 | 15 | 15 |
| Broth | 70 | 70 | 50 | 50 | 20 | 20 |
| Total | 100 | 100 | 100 | 100 | 100 | 100 |

Results.

A(L): Small clumps of gelatin remained in liquid after mixing. Extremely foamy liquid, very soft once set, released from mold cleanly, green and white mold were present on product 6 days after production.

A(M): Foamy liquid, produced a slightly tacky product, released cleanly from the old with little to no product damage, white mold was present on product 6 days after production.

A(H): Only had 5 g of boiling broth mixed into starch because the liquid level was so low, mixture did not dissolve into cohesive mass, the mixture had a gritty clumpy texture, spreadable thick liquid, mixture spread into mold, product was very resilient to downward pressure, mixture was almost too thick for the blender to handle, no mold was present on product 6 days after production.

B(L): Trial mixed well, extremely foamy, product did not release well from mold. There was product damage when the products were released from the mold. White mold was present on product 6 days after production.

B(M): Foamy liquid. Product was very soft and tacky, did not release from mold easily, and was damaged releasing it from the mold. White mold was present on product 6 days after production.

B(H): Did not mix completely. No broth was mixed with the starch; all broth was mixed with gelatin instead. Very gritty texture, small clumps visible, the mixture had a streaked appearance, mixture was forced into molds, product was released from mold cleanly. No mold was present on product 6 days after production.

C(L): Mixture was very thin. No broth was mixed with the starch; all broth was mixed with gelatin. Liquid was very foamy, product did not release cleanly from mold and product damage resulted. White mold was present on product 6 days after production.

C(M): Liquid mixed well, mixture was very foamy. No broth was mixed with the starch; all broth was mixed with gelatin. Product did not release cleanly from mold resulting in product damage. No mold was present on product 6 days after production.

C(H): all liquid ingredients and starch mix were poured onto the gelatin then blended together, mixture was too much for blender too handle so mixing was finished by hand. Mixture was uniform dark brown color, mixture was not foamy, mixture was very thick pourable liquid. Product was slightly tacky, rigid, with minimal to some damage created by releasing the product from the mold. No mold was present on product 6 days after production.

TABLE 9
Water Activity Tests.
Water Activity Test (3 days after production)

| Trial | Water Activity | Temperature (° C.) |
|---|---|---|
| C(H) | 0.77 | 17.9 |
| C(M) | 0.92 | 16.9 |
| C(L) | 0.96 | 17.6 |
| B(H) | 0.78 | 16.9 |
| B(M) | 0.93 | 16.6 |
| B(L) | 0.98 | 16.5 |
| A(H) | 0.79 | 16.8 |
| B(M) | 0.91 | 17.6 |
| B(L) | 0.97 | 17.5 |

TABLE 10
Additional Water Activity Tests.
Additional Water Activity Tests Performed

| Date Performed | Trial | Water Activity | Temperature (° C.) |
|---|---|---|---|
| 6 days after production | C(H) | 0.76 | 18.4 |
| 15 days after production | C(H) | 0.76 | 23.4 |

Conclusions.

Unless used in high amounts, the Pro Bind gelatin did not produce a stable product at room temperature (75° F.). The lowest combinations of gelatin may not be enough to yield desired product. The middle range trials had better results than the low inclusion trials. The higher amounts of A and B trials may be too thick to produce desired products. Trial C(H) produced the sample closest to the desired product. Water activity of trial C(H) remained fairly constant over varying temperatures. Water activity for all samples may be too high.

### Example VIII

Background.

It was concluded that trial C(H) from Example VII was the product most desired, but the water activity was likely too high for a long shelf life. It was decided to test the addition of potassium sorbate for its mold inhibitor properties under semi-moist conditions. A mixture of tapioca and native potato starch was also tested for its structural support and water binding properties. It was believed that the addition of potassium sorbate would prohibit mold growth within the product and that mixing the tapioca and potato starches would provide greater product stability and water binding than potato starch alone.

Ingredients and Equipment.

The ingredients for this experiment are the same as Example VII with the addition of Nantong Acetic Acid Chemical Company Potassium Sorbate. The equipment used for this experiment is the same as Example VII, except no immersion blender was used.

Procedure.

First, chicken broth was heated to boiling. Next, boiling tap water was poured into two beakers, and a jar of molasses and a graduated cylinder were placed in separate beakers filled with water to warm. Then, starch(s) were weighed out for all trials in weigh boats, with the starches being mixed completely if more than one starch was used in the trial. Then, vegetable glycerin was weighed out and poured into the starch mixture and mixed completely. Then, gelatin was weighed out for all trials and placed in beakers. Then, potassium sorbate was weighed out for all trials, combined with gelatin, and mixed completely. Heated molasses was weighed out into a heated graduated cylinder and poured into starch/glycerin mixture. The starch/glycerin/molasses mixture was poured into a dry beaker. Boiling chicken broth was weighed out and poured into the starch/glycerin/molasses mixture and combined. The starch/glycerin/molasses/broth mixture was microwaved for 20 seconds and swirled to recombine. This mixture was poured into the gelatin/sorbate mixture and mixed until combined. The product was poured into mold and covered with tin foil. The amounts of each ingredient used in trials A, B, C, and D are shown in Tables 11, 12, 13, and 14, respectively.

TABLE 11
Trial A.
Trial A (H) and A(C)

| Ingredient | g | % |
|---|---|---|
| Pro Bind | 35 | 34.65 |
| Molasses | 15 | 14.85 |
| Glycerin | 15 | 14.85 |
| Potato Starch | 15 | 14.85 |
| Potassium Sorbate | 1 | 1 |
| Chicken Broth | 20 | 19.8 |
| Total | 101 | 100 |

TABLE 12
Trial B.
Trial B

| Ingredient | g | % |
|---|---|---|
| Pro Bind | 30 | 29.7 |
| R 250 | 5 | 4.95 |
| Molasses | 15 | 14.85 |
| Glycerin | 10 | 9.9 |
| Potato Starch | 20 | 19.8 |
| Potassium Sorbate | 1 | 1 |
| Chicken Broth | 20 | 19.8 |
| Total | 101 | 100 |

TABLE 13
Trial C.
Trial C

| Ingredient | g | % |
|---|---|---|
| Pro Bind | 35 | 34.65 |
| Molasses | 15 | 14.85 |
| Vegetable Glycerin | 15 | 14.85 |
| Tapioca Starch | 15 | 14.85 |
| Potassium Sorbate | 1 | 1 |
| Chicken Broth | 20 | 19.8 |
| Total | 101 | 100 |

TABLE 14
Trial D.
Trial D

| Ingredient | g | % |
|---|---|---|
| Pro Bind | 30 | 29.7 |
| R 250 | 5 | 4.95 |
| Molasses | 15 | 14.85 |
| Vegetable Glycerin | 10 | 9.9 |
| Tapioca Starch | 10 | 9.9 |
| Potato Starch | 10 | 9.9 |
| Potassium Sorbate | 1 | 1 |
| Chicken Broth | 20 | 19.8 |
| Total | 101 | 100 |

Results.

A(C): Liquid mixed up like peanut butter, minimal to no clumps of gelatin. Mixture was pressed/spread into mold. This was the lightest colored of all trials (light tan).

A(H): Liquid mixed well with minimal to no clumping, thinnest mixture of all trials. Poured into mold with no problems. Dark brown colored product.

B: Thick, pourable liquid when mixed, liquid mixed completely with little to no clumping. Dark brown colored product.

C: Liquid mixed well, pourable mixture, minimal to no clumping of gelatin. Slightly lighter brown than trial B, lighter color may be caused by tapioca starch.

D: Liquid mixed well, thick pourable mixture, mixture had little to no clumps of gelatin. Color of product was similar to trial C, lighter color may be caused by tapioca starch.

All treatments would not release from mold at 77° F. and 42% humidity. Mold was placed in refrigerator at ˜4° C.
A(H) released cleanly from mold after 15 minutes in refrigerator.
A(C) released cleanly from mold after 30 minutes in refrigerator.
B released cleanly from mold after 30 minutes in refrigerator.
C released cleanly from mold after 2 hours and 45 minutes in refrigerator.
D released cleanly from mold after 2 hours and 45 minutes in refrigerator.

TABLE 15
Water Activity Tests.
Water Activity on 3 days after production

| Trial | Water Activity | Temperature (° C.) |
|---|---|---|
| A(H) | 0.75 | 22.5 |
| A(C) | 0.73 | 23.1 |
| B | 0.77 | 22.7 |
| C | 0.72 | 23.2 |
| D | 0.77 | 27.6 |

Conclusions.

Trial A(H) was the closest to the desired product. Trial D was the next closest and had an average piece weight equal to trial A(H). The liquid must be hot in order for the product to set-up with desired characteristics. If the liquid is cold, the mixture may not produce desired characteristics. The addition of tapioca starch created a lighter color in the trials C and D. There were many fine air bubbles within all of the mixtures, but no foam was created when mixing the ingredients together by hand.

The above examples show it is possible to create a gelatin based dog treat that overcomes the challenge of gelatin's thermoplastic properties up to 78° F. in direct sunlight. The formula may also be modified to include multipurpose ingredients that impart both flavor and coloring into the treats.

### Example IX

Background.

Formulations were tested to determine how variations in the formulation components affect the product characteristics. The objective testing measures considered were: shelf life, water activity, moisture analysis, and texture profile analysis.

Ingredients and Equipment.

The ingredients used in the production of the dog treat samples were: Sonac Probind Plus 50 gelatin, Rousselot Pig Skin 100 gelatin, Grandma's brand molasses, Frontier brand vegetable glycerin, Bob's Red Mill native potato starch, Bob's Red Mill native tapioca starch, chicken broth, and Natnong brand potassium sorbate. The equipment needed for the production of the samples included a hot plate, 100 ml glass beakers, stir rods, graduated cylinders, and other typical lab equipment.

Four trials were decided upon with gelatin inclusion rates of 35%, starch inclusion rates of 15-20%, molasses inclusion rates of 10-15%, vegetable glycerin inclusion rates of 15%, inclusion of chicken broth at 20%, and potassium sorbate included at 1%. The formulation of Trial A was found to be the most desirable of the formulations tested in the above examples and as such was chosen as the base formulation for this experiment. Trial A has only the Probind gelatin and potato starch as its main structural components. Trial B includes the addition of Rousselot Pig Skin 100 gelatin to measure the effect of an additional high Bloom gelatin. The amount of molasses was decreased to allow for the greater concentration of vegetable glycerin to study the impact it would have on water activity, since vegetable glycerin acts as a binder of free water in the product. Trial C was formulated from the base formula (Trial A) but includes tapioca starch as the second structural component of the dog treat alongside the Sonac Probind gelatin. This inclusion was established to test the differences between tapioca and potato starch within the dog treats for use in the final formulation. Trial D includes both the Sonac Probind and Rousselot Pig Skin 100 gelatins with potato and tapioca starches to give the best chance at retaining solid state stability at higher temperatures. This formulation has the greatest variety in structural components of the four trials. The formulations of the four trials are included in the tables below.

TABLE 16
Trial A formulation.
Trial A

| Ingredient | g | % |
|---|---|---|
| Pro Bind | 35 | 34.65 |
| Molasses | 15 | 14.85 |
| Glycerin | 15 | 14.85 |
| Potato Starch | 15 | 14.85 |
| Potassium Sorbate | 1 | 1 |
| Chicken Broth | 20 | 19.8 |
| Total | 101 | 100 |

TABLE 17
Trial B formulation.
Trial B

| Ingredient | g | % |
|---|---|---|
| Pro Bind | 11 | 10.89 |
| R 100 PS | 24 | 23.76 |
| Molasses | 10 | 9.9 |
| Glycerin | 15 | 14.85 |
| Potato Starch | 20 | 19.8 |
| Potassium Sorbate | 1 | 1 |
| Chicken Broth | 20 | 19.8 |
| Total | 101 | 100 |

TABLE 18
Trial C formulation.
Trial B

| Ingredient | g | % |
|---|---|---|
| Pro Bind | 35 | 34.65 |
| Molasses | 15 | 14.85 |
| Vegetable Glycerin | 15 | 14.85 |
| Tapioca Starch | 15 | 14.85 |
| Potassium Sorbate | 1 | 1 |
| Chicken Broth | 20 | 19.8 |
| Total | 101 | 100 |

TABLE 19
Trial D formulation.
Trial D

| Ingredient | g | % |
|---|---|---|
| Pro Bind | 11 | 10.89 |
| R 100 PS | 24 | 23.76 |
| Molasses | 10 | 9.9 |
| Vegetable Glycerin | 15 | 14.85 |
| Tapioca Starch | 10 | 9.9 |
| Potato Starch | 10 | 9.9 |
| Potassium Sorbate | 1 | 1 |
| Chicken Broth | 20 | 19.8 |
| Total | 101 | 100 |

The samples were produced by placing the jar of molasses into a hot water bath and heating the chicken broth to boiling (100° C. (212° F.)). All dry ingredients (gelatin(s), starch(s), potassium sorbate) were weighed out to within 0.1 grams specified by the formulation. The potassium sorbate and gelatin(s) were mixed together until combined. Next, the starch, vegetable glycerin, and molasses were mixed together in a weigh boat and allowed to cool until needed later in production, approximately 2 to 3 minutes. The necessary amount of chicken broth was then measured in a graduated cylinder, poured into a beaker, and placed upon a hot plate set to medium heat. Once the correct amount of chicken broth returned to a boil, the starch, vegetable glycerin, and molasses mixture was added and heated until steam could be easily observed rising from the surface while being stirred. Slowly, the gelatin(s) and potassium sorbate mixture were added to the liquids as the stirring motion continued. Once all ingredients were added, the mixture was stirred upon the hot plate until dark caramel colored streaks appeared. At that point, the mixture was ready to be poured into the mold. Because the mixture sets quickly only one small 100 gram batch could be made at a time. This limitation meant that 3 to 4 small 100 gram batches were needed of each of the four formulations to produce enough samples.

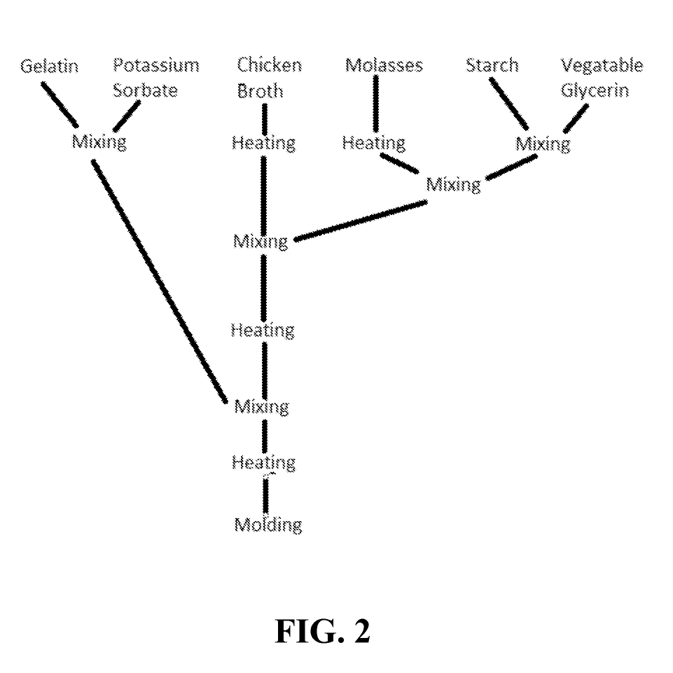

A flow diagram providing a visual representation of the procedure for preparing the samples above is shown in FIG. 2.

Testing. Shelf Life Study.

The shelf life of the dog treats was evaluated for a total of 4 months. The samples were grouped by trial and placed in isolation in clear zip top bags with the excess air removed. The bags remained on the counter top in the lab exposed to ambient temperatures of 10° C. to 25.55° C. (50° F. to 78° F.) and varying degrees of sunlight (afternoon sunlight). Very little equipment was needed for the shelf life study. The only additional equipment needed was four clear zip top bags.

Testing. Water Activity.

Water activity was measured by means of a Decagon CX-2 water activity meter (Decagon Devices, Pullman, Wash.). Water activity was measured on weeks: 2, 4, 6, 8, 12, and 16, according to protocol discussed by Anthony J. Fontana Jr. et. al. in Water Activity in Foods: Fundamentals and Applications, with minor modifications. The gummy nature of the product required that the samples be sliced in half for testing. All samples tested for water activity were taken from the sample bags subjected to the shelf life study. This allowed for a more accurate measurement of the changes in water activity throughout the 4 months of the shelf life testing.

The temperatures at time of testing ranged from 23.3° C. to 26.9° C. (74° F. to 80.42° F.). Briefly, three samples were taken from each formulation bag. Each sample was sliced down the middle to produce two pieces half the height of the original sample. Of those two sub-samples, one was placed cut side down into a sample cup and placed into the water activity meter for testing. Because water activity is dependent upon water vapor pressure as a variable in measuring water activity, and both are reliant on temperature, it was hypothesized that water activity would lower as the temperature lowered according to the Clausius-Clapeyron equation. (Labuza 1968, Roos 1995, Fontana Jr. 2007).

Testing. Texture Profile Analysis.

Texture measurements were performed with TA.XT2i Texture Analyzer (Texture Technologies Corp., Scarsdale, N.Y.), equipped with 50-kg load cells and a 25 mm cylindrical probe. (Dogan and Kokini, 2007). Five samples from each treatment underwent texture profile analysis. Only peak force was measured, using current software. (Dogan, 2013). The five sub samples from each formulation were chosen for the texture profile analysis testing based upon visual inspection for lack of observable defects, such as large air bubbles or open pockets that formed during production of the dog treats. All excess webbing was removed from the sub samples before texture profile analysis testing was conducted. The testing parameters were a pretest speed of 1 mm/sec, a test speed of 0.5 mm/sec, and a post test speed of 10 mm/sec. The strain load for the tests was set at 50%. Statistical analysis of the maximum force readings was performed using the GLIMMIX procedure of SAS. Results are provided in Table 21, below.

Testing. Moisture Analysis.

Moisture analysis was performed using the Kansas State University Feed Science Lab Protocol for drying/grinding Feces or Excreta, with minor modifications. (Jones, 2013). The drying oven was set at 70° C. (158.0° F.) for 48 hours then increased to 80° C. (176.0° F.) for a total time period of 15 days. The

$$MC = \frac{Initial weight - Oven \text{-} dry weight}{Oven \text{-} dry weight} 100 \%$$

temperature settings for this protocol were chosen to ensure proper drying of the samples without altering the structural or nutritional composition of each treatment. Five samples from each formulation were weighed into aluminum weight boats and placed into the drying oven. The samples were removed from the oven and weighed on days 2, 3, 4, 7, 8, 9, 10, 11, and 14. The percent moisture loss was calculated using the formula given by Oregon State University:

Results. Shelf Life Study.

Shelf life was conducted by means of visual observation. The samples were placed on a bench top in the laboratory to expose the samples to the greatest range of environmental changes over the four months the study took place. There were no apparent mold growths upon any of the samples. All samples were exposed to temperatures ranging from 10° C. to 25.55° C. (50° F. to 78° F.). Treatments A and C had a noticeable ring located just inside the outer edge of the samples. The cause for this ring is unknown. Treatments A and C also appeared to be a smoother texture with less air bubbles present than that of Treatments B and D. All trials retained their shape and solid state characteristics throughout the study and did not melt or become liquid within the zip top bags. There were no apparent color changes to any of the samples or other visually observable changes to any of the samples.

Results. Water Activity.

Water activity was measured by means of a Decagon CX-2 water activity meter (Decagon Devices, Pullman, Wash.). The table below shows the averages for each of the formulations for the given week of testing. The temperatures at time of testing ranged from 23.3° C. to 26.9° C. (74° F. to 80.42° F.).

TABLE 20
Water Activity

| | Treatment A | Treatment B | Treatment C | Treatment D |
|---|---|---|---|---|
| Week 2 | 0.748 @ 24.4° C. | 0.780 @ 24.7° C. | 0.742 @ 24.8° C. | 0.770 @ 24.3° C. |
| Week 4 | 0.735 @ 24.5° C. | 0.749 @ 24.6° C. | 0.723 @ 24.4° C. | 0.716 @ 24.3° C. |
| Week 6 | 0.729 @ 24.5° C. | 0.715 @ 24.6° C. | 0.647 @ 24.7° C. | 0.661 @ 24.1° C. |
| Week 8 | 0.716 @ 23.8° C. | 0.724 @ 23.8° C. | 0.662 @ 23.8° C. | 0.674 @ 24.2° C. |
| Week 12 | 0.673 @ 26.4° C. | 0.679 @ 26.5° C. | 0.622 @ 26.5° C. | 0.656 @ 26.9° C. |
| Week 16 | 0.672 @ 23.3° C. | 0.681 @ 23.4° C. | 0.623 @ 23.9° C. | 0.638 @ 24.1° C. |

Results. Texture Profile Analysis.

Texture profile analysis was completed using the TA.XT2i Texture Analyzer (Texture Technologies Corp., Scarsdale, N.Y.), equipped with 50-kg load cells and a 25 mm conical probe according to Dogan and Kokini (2007) with minor modifications. The table below shows the maximum force rating of the four trials, as analyzed by the GLIMMIX procedure of SAS. The texture analyzer was not able to get a reading for the stickiness value of the gelatin based dog treats because the treats remained stuck to the probe as the probe released pressure from the treat and retracted at the end of the test.

TABLE 21
Force Deformation of Gelatin Dog Treats.

| | Treatment | | | | |
|---|---|---|---|---|---|
| | A | Treatment B | Treatment C | Treatment D | SEM |
| Force, Kg | 0.74 | 2.72 | 0.83 | 2.54 | 0.123 |

Results. Moisture Analysis.

Moisture analysis was performed using the KSU Feed Science Lab Protocol for drying/grinding Feces or Excreta, with minor modifications. The table below shows the total percent moisture loss averages for each day the samples were taken out of the drying oven and weighed.

TABLE 22
Percent Total Moisture Loss
Percent Total Moisture Loss

| Day | Trial A | Trial B | Trial C | Trial D |
|---|---|---|---|---|
| 2 | 9.14 | 10.34 | 9.44 | 9.89 |
| 3 | 11.17 | 12.50 | 11.65 | 12.18 |
| 4 | 12.72 | 14.11 | 13.03 | 13.50 |
| 7 | 15.01 | 16.28 | 15.21 | 15.57 |
| 8 | 15.63 | 16.73 | 15.70 | 16.11 |
| 9 | 16.74 | 17.50 | 16.51 | 16.89 |
| 10 | 17.18 | 17.78 | 16.83 | 17.21 |
| 11 | 17.85 | 18.48 | 17.64 | 17.89 |
| 14 | 19.15 | 18.65 | 17.71 | 18.07 |

The lowest average total percent moisture loss was that of Trial C, with a percent moisture loss of 17.71% over the 15 day study. The highest average total percent moisture loss was that of Trial A with 19.15% over the course of study. It was observed that certain samples began to cave in the center over time. The samples were malleable to the touch but had not changed over to a liquid state. Only treatments A and C were observed to have any changes in physical appearance during the moisture analysis study. Treatments B and D had no visible changes to the samples but were also malleable to the touch and did not change into a liquid state.

Discussion. Shelf Life Study.

During the shelf life study, the samples were exposed to a range of ambient temperatures, humidity, and light levels. The temperature changes did not seem to affect the shelf life of the four gelatin dog treat formulations. The changing light levels did not seem to effect the samples either.

Discussion. Water Activity.

The water activity of Treatment A decreased by 0.076 over the course of 14 weeks between weeks 2 and week 16. Treatment B decreased by 0.099 over the time period. Treatment C decreased by 0.119, and Treatment D decreased by 0.132 over 14 weeks. Treatment A's water activity declined every week of testing. However, Treatments B, C, and D showed a water activity decrease as time went on, except for an increase of water activity on week 8 of the shelf life test. Treatment C had the lowest water activity at the beginning of the shelf life study with 0.742 at 24.8° C. (76.64° F.) and the lowest of the averages at week 16 with a water activity of 0.623 at 24.1° C. (75.38° F.). Treatment B, on average, had the highest water activity of the four treatments during the shelf life study with 0.780 at 24.7° C. (76.46° F.) at week 2 and a water activity of 0.681 at 23.4° C. (74.12° F.) at week 16. There was a general trend of both water activity and temperature lowering over the course of the four month shelf life study. The temperature decrease could be attributed to decreased output of the heaters in the laboratory over the winter and spring months. It may be possible that the clear zip top bags containing the samples may not have been completely air tight. If so, this would have facilitated the slow process of evaporation of moisture from the gelatin dog treats and consequently lowered the measurable water activity of the treats.

Discussion. Texture Profile Analysis.

The texture profile analysis data showed that there was no statistical difference between the native potato starch and the native tapioca starch on the structural properties of the gelatin based dog treat. The analysis also showed that there was no statistical difference between the addition of equal amounts of native potato starch and tapioca starch compared to just using native potato starch alone. The data did show, however, that there was a statistical difference between the treatments that included the higher bloom strength Rousselot Pig Skin 100 gelatin (Treatments B and D) compared to the treatments that only utilized the lower bloom strength Sonac Probind 50 Plus gelatin (Treatments A and C). Thus, the data shows that the higher bloom strength gelatin, in combination with the Sonac Probind 50 Plus gelatin, created a stronger matrix of hydrogen bonds surrounding the starch molecules than the lower bloom strength gelatin could alone and therefore required greater force acted upon those samples.

Discussion. Moisture Analysis.

The final moisture analysis percentages were near the lower end of the hypothesized range (20%). Also as hypothesized, the greatest amount of moisture loss occurred at the beginning of the study, within the first five days of the samples being placed in the drying oven. All of the samples retained the molded shape and did not become a liquid in the higher temperatures. This was a significant discovery, as the gelatin based dog treats will need to retain their molded shape during shipping and storage where temperatures can vary depending upon the time of year.

Conclusion.

It can be concluded that shelf life, water activity, texture profile analysis, and moisture content can all be used as objective testing measures for the gelatin based, gummy textured, dog or cat treats. Shelf life, while not having many numerical values associated with it can be used as a means to test the dog treats for microbial mold growth, temperature stability, and storage time limitations. Water activity provides additional information on the capability of microbial hazards and potential for mold growth when combined with the shelf life study to give understanding to the variables of the product after production. Based upon texture profile analysis a higher strength gelatin creates a gelatin based dog treat that requires a greater amount of force to be applied when eaten.

1. A process of forming an animal treat comprising:
forming a composition comprising a gelatin component, a carbohydrate material, and an aqueous liquid, wherein said composition comprises less than about 1% by weight of acidulants;
introducing said composition into a product mold and causing said composition to harden within said product mold, thereby forming said animal treat.

2. The process of claim 1, wherein said composition comprises from about 15% to about 50% by weight of said gelatin component.

3. The process of claim 1, said gelatin component comprising at least one gelatin having a Bloom value from about 50 to about 275.

4. The process of claim 1, said gelatin component comprising at least two gelatins having different Bloom values.

5. The process of claim 4, wherein at least one of said gelatins has a Bloom value of about 50 or greater.

6. The process of claim 1, wherein said composition is heated before being introduced into said product mold.

7. The process of claim 1, wherein said carbohydrate material and aqueous liquid are heated prior to being mixed with said gelatin component.

8. The process of claim 1, wherein said composition has a temperature greater than 80° F. when introduced into said product mold.

9. The process of claim 8, wherein said step of causing said composition to harden within said product mold comprises lowering the temperature of said mixture within said product mold to 80° F. or below.

10. The process of claim 1, wherein said carbohydrate material comprises at least one polysaccharide component.

11. The process of claim 1, wherein said at least one polysaccharide component is a starch derived from a root vegetable source.

12. The process of claim 1, wherein said aqueous liquid is a flavored broth.

13. The process of claim 1, wherein said composition further comprises a polyhydric alcohol.

14. The process of claim 1, wherein said composition further comprises a non-starch monosaccharide or oligosaccharide.

15. The process of claim 1, wherein said animal treat further comprises a pharmaceutical agent.

16. The process of claim 1, wherein said animal treat comprises less than about 5% by weight of fat.

17. The process of claim 1, wherein said forming step comprises separately mixing said carbohydrate material with a portion of said aqueous liquid to form a first mixture and mixing said gelatin component with another portion of said aqueous liquid to form a second mixture, said first and second mixtures are combined to form said composition.

18. The process of claim 1, wherein said forming step comprises separately mixing said carbohydrate material with said aqueous liquid to form a mixture, and adding said gelatin component to said mixture to form said composition.

19. The process of claim 1, wherein said composition has a pH of from about 5.0 to about 8.0.

20. A process of forming an animal treat comprising:
forming a composition comprising a gelatin component, a carbohydrate material, and an aqueous liquid, wherein said composition has a pH of from about 5.5 to about 8.0; and
introducing said composition into a product mold and causing said composition to harden within said product mold, thereby forming said animal treat.

21. An animal treat composition comprising an admixture of a gelatin component, a carbohydrate material, and an aqueous liquid, wherein said composition comprises less than about 1% by weight of acidulants.

22. The composition of claim 21, wherein said composition is a liquid animal treat precursor.

23. The composition of claim 22, wherein said liquid animal treat precursor has a pH of about 5.5 to about 8.0.

24. The composition of claim 21, wherein said composition comprises from about 15% to about 50% by weight of said gelatin component.

25. The composition of claim 21, said gelatin component comprising at least one gelatin having a Bloom value from about 50 to about 275.

26. The composition of claim 21, said gelatin component comprising at least two gelatins having different Bloom values.

27. The composition of claim 26, wherein at least one of said gelatins has a Bloom value of about 50 or greater.

28. The composition of claim 21, wherein said carbohydrate material comprises at least one polysaccharide component.

29. The composition of claim 28, wherein said at least one polysaccharide component is a starch derived from a root vegetable source.

30. The composition of claim 21, wherein said aqueous liquid is a flavored broth.

31. The composition of claim 21, wherein said composition further comprises a polyhydric alcohol.

32. The composition of claim 21, wherein said composition further comprises a non-starch monosaccharide or oligosaccharide.

33. The composition of claim 21, wherein said composition further comprises a pharmaceutical component.

34. The composition of claim 21, wherein said composition comprises less than about 5% by weight of fat.

35. The composition of claim 21, wherein said composition is a solid animal treat.

36. The composition of claim 35, wherein said solid animal treat has a deformation peak force of about 0.3 kg to about 4.0 kg as determined using a TA.XT2i Texture Analyzer equipped with 50-kg load cells and a 25 mm conical probe.

37. The composition of claim 35, wherein said solid animal treat exhibits less than 20% moisture loss after 15 days in a drying oven operating at a temperature of 158.0° F.

38. The composition of claim 35, wherein said solid animal treat has a shelf life of at least 30 days at 75° F. when stored in a reclosable container.

39. The composition of claim 21, wherein said gelatin component comprises at least 75% by weight of the entire protein content of said composition.

40. The composition of claim 21, wherein said composition comprises less than 5% by weight of non-gelatin animal-derived protein.

41. The composition of claim 21, wherein said composition comprises from about 5% to about 60% by weight of said carbohydrate material.

42. A method of feeding an animal comprising feeding the animal a composition according to claim 21.
